(19) United States
(12) Patent Application Publication
(10) Pub. No.: US 2010/0064044 A1
(43) Pub. Date: Mar. 11, 2010

(54) Information Processing System and Control Method for Information Processing System

(75) Inventor: Akihiro Nonoyama, Komae-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/535,797

(22) Filed: Aug. 5, 2009

(30) Foreign Application Priority Data
Sep. 5, 2008 (JP) 2008-228737

(51) Int. Cl. G06F 15/173

(52) U.S. Cl. 709/226

(57) ABSTRACT

According to one embodiment, an information processing system includes a managed information processing apparatus connected with a network, and a plurality of first information processing apparatuses including a first monitor module which controls each software resource to simultaneously run on one hardware resource, the software resources including a first software resource including a first program has a function of administrating security information required to control an operation of the managed information processing apparatus, wherein one first information processing apparatus selected from the plurality of first information processing apparatuses executes the first program, and the security information of the one selected first information processing apparatus is synchronized with that of a newly selected first information processing apparatus when changing the first information processing apparatus which executes the first program from the selected first information processing apparatus to the newly selected first information processing apparatus,

### CROSS-REFERENCE TO RELATED APPLICATIONS

This application is based upon and claims the benefit of priority from Japanese Patent Application No. 2008-228737, filed Sep. 5, 2008, the entire contents of which are incorporated herein by reference.

### BACKGROUND

1. Field

One embodiment of the invention relates to an information processing system having a managed computer whose operation is controlled based on a security policy distributed from a server and to a control method for the information processing system.

2. Description of the Related Art

In a conventional administration solution for, e.g., PC administration, a structure in which a core server as an administrative machine administrates a managed computer as a client is common. Introducing a dedicated server machine is a bottleneck of introduction in, e.g., small businesses that require an administrator having certain skills.

Jpn. Pat. Appln. KOKAI Publication. No. 2008-83897 discloses a structure where a virtual machine is configured as a client machine to run a server program.

When a virtual technique is adopted in a general computer (a desktop or notebook personal computer) which is not for a server application and is utilized by a user, an administration solution for, e.g., PC administration can be realized even if a dedicated server is not used.

However, in a case where the virtual technique is utilized in a computer used by a user to configure a server, there occurs an inconvenience that the server disappears when the computer in which the server is configured is taken out in an environment where the user can take out the computer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a structure of an information processing system according to an embodiment of the present invention;

FIG. 2 is an exemplary view showing an information linkage between servers and clients in an administrative system utilizing a virtual system according to an embodiment of the present invention;

FIG. 3 is an exemplary block diagram showing a system configuration of an administrative computer according to an embodiment of the present invention;

FIG. 4 is an exemplary view showing a setting screen that is used to set an administrative server;

FIG. 5 is an exemplary view showing a display screen that is used to switch administrative servers;

FIG. 6 is an exemplary view showing a display screen that is used to retrieve a device;

FIG. 7 is an exemplary view showing a setting screen that is used to browse a log;

FIG. 8 is an exemplary view showing a displays screen that is used to set a security policy in each target administration computer;

FIG. 9 is an exemplary view showing a security setting screen that is displayed when a check mark is placed in a check box that is used to set the security in detail;

FIG. 10 is an exemplary view showing a screen that is used to set an “OS security policy” depicted in FIG. 9 in detail;

FIG. 11 is an exemplary view showing a structure of an information processing system according to an embodiment of the present invention;

FIG. 12 is an exemplary view showing an information linkage between servers and clients in an administrative system utilizing a vertical system according to an embodiment of the present invention;

FIG. 13 is an exemplary view showing a virtual server system based on vertical distribution according to an embodiment of the present invention;

FIG. 14 is an exemplary view showing a virtual server system based on horizontal distribution according to an embodiment of the present invention;

FIG. 15 is an exemplary view showing an implementation example that realizes a distribution environment;

FIG. 16 is an exemplary sequence diagram showing a procedure of processing executed by a configuration administrative manager, an operation administrative manager, a resource administrative manager, and a work monitoring manager;

FIG. 17 is an exemplary sequence diagram showing the procedure of processing executed by the configuration administrative manager, the operation administrative manager, the resource administrative manager, and the work monitoring manager;

FIG. 18 is an exemplary sequence diagram showing the procedure of processing executed by the configuration administrative manager, the operation administrative manager, the resource administrative manager, and the work monitoring manager;

FIG. 19 is an exemplary sequence diagram showing the procedure of processing executed by the configuration administrative manager, the operation administrative manager, the resource administrative manager, and the work monitoring manager; and

FIG. 20 is an exemplary sequence diagram showing the procedure of processing executed by the configuration administrative manager, the operation administrative manager, the resource administrative manager, and the work monitoring manager.

### DETAILED DESCRIPTION

Various embodiments according to the invention will be described hereinafter with reference to the accompanying drawings. In general, according to one embodiment of the invention, an information processing system comprises a managed information processing apparatus connected with a network, a plurality of first information processing apparatuses connected with the network, the first information processing apparatus including a first monitor module which controls each software resource to simultaneously run on one hardware resource, the software resources including a first software resource including a first operating system and a first program which runs on the first operating system and has a function of administrating security information required to control an operation of the managed information processing apparatus, a plurality of second information processing apparatuses connected with the network, the second information processing apparatus including a second monitor module which controls each software resource to simultaneously run on one hardware resource, the software resources including a second software resource including a second operating system and a second program which runs on the second operating system and has a function of collecting and saving log information indicative of an administration status in the managed information processing apparatus, a plurality of third information processing apparatuses connected with the network, the third information processing apparatus including a third monitor module which controls each software resource to simultaneously run on one hardware resource, the software resources including a third software resource including a third operating system and a third program which runs on the third operating system and has a function of administrating user information which uses the managed information processing apparatus, and a plurality of fourth information processing apparatuses connected with the network, the fourth information processing apparatus including the fourth monitor module which controls each software resource to simultaneously run on one hardware resource, the software resources including a fourth software resource including the fourth operating system and a fourth program which runs on the fourth operating system and has a function of administrating device information which uses the managed information processing apparatus, wherein one first information processing apparatus selected from the plurality of first information processing apparatuses executes the first program, and the security information of the one selected first information processing apparatus is synchronized with that of a newly selected first information processing apparatus when changing the first information processing apparatus which executes the first program from the selected first information processing apparatus to the newly selected first information processing apparatus, one second information processing apparatus selected from the plurality of second information processing apparatuses executes the second program, and the log information of the one selected second information processing apparatus is synchronized with that of a newly selected second information processing apparatus when changing the second information processing apparatus which executes the second program from the one selected second information processing apparatus to the newly selected second information processing apparatus, one third information processing apparatus selected from the plurality of third information processing apparatuses executes the third program, and the user information of the one selected third information processing apparatus is synchronized with that of a newly selected third information processing apparatus when changing the third information processing apparatus which executes the third program from the one selected third information processing apparatus to the newly selected third information processing apparatus, and one fourth information processing apparatus selected from the plurality of fourth information processing apparatuses executes the fourth program, and the device information of the one selected fourth information processing apparatus is synchronized with that of a newly selected fourth information processing apparatus when changing the fourth information processing apparatus which executes the fourth program from the one selected fourth information processing apparatus to the newly selected fourth information processing apparatus.

Embodiments according to the present invention will now be described hereinafter with reference to the drawings.

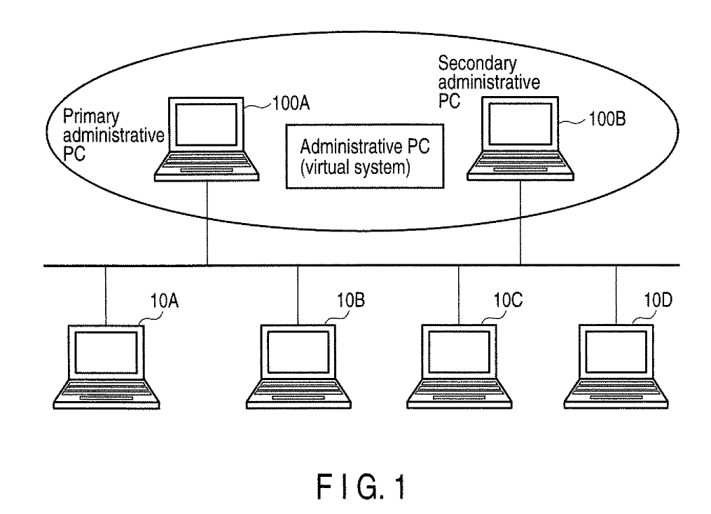

FIG. 1 is an exemplary view showing a structure of an information processing system according to an embodiment of the present invention.

As shown in FIG. 1, the system is constituted of a primary administrative computer 100A, a secondary administrative computer 100B, target administration computers 10A to 10D, and others.

An operating system used in the target administration computers 10A to 10D is, e.g., Windows (a registered trademark) manufactured by Microsoft Corporation.

Each of the primary administrative computer 100A and the secondary administrative computer 100B has a function of operating as a security server and executes processing of, e.g., distributing a security policy to the target administration computers 10A to 10D. It is to be noted that the security server function performed in each of the primary administrative computer 100A and the secondary administrative computer 100B does not simultaneously run in both the primary administrative computer 100A and the secondary administrative computer 100B, but one of the primary administrative computer 100A and the secondary administrative computer 1008 executes the security server function.

Further, each of the primary administrative computer 100A and the secondary administrative computer 100B is not a dedicated computer that executes the security server function. Each of the primary administrative computer 100A and the secondary administrative computer 100B is a computer which is usually utilized by a user like the target administration computers 10A to 10D.

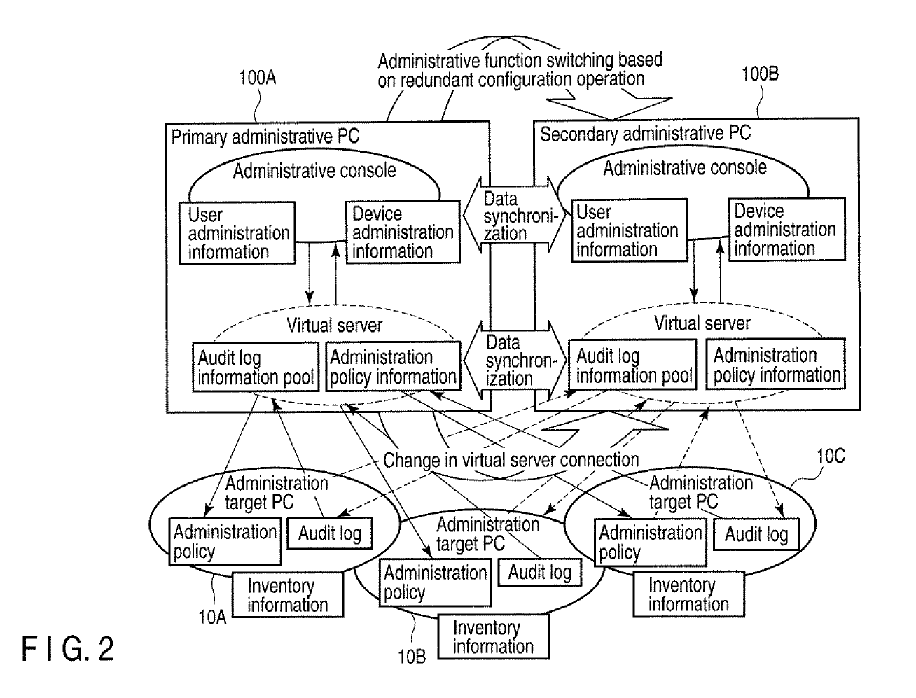

As shown in FIG. 2, in each of the primary administrative computer 100A and the secondary administrative computer 100B, a virtual server that executes the security server function can be carried out. The virtual server administrates data, e.g., administration policy information or audit log information. The administration policy information includes a security policy that is distributed to the target administration computers 10A to 10D. The audit log information is an audit policy collected from the respective target administration computers 10A to 10D. As the audit policy information, there are several types, such as an account logon event, account administration, object access, a system event, access to a directory service, process tracking, a change in policy, use of a privilege, and others.

The account logon event is an event log output of, e.g., logon/logoff through a network. The account administration is an event log output of, e.g., creation or change of a user account or a group, and others. The object access is an event log output of, e.g., retrieval of a file, a folder, or an object, a user operation, a computer operation, and others. The system event is an event log output of, e.g., shutdown/reboot, changing/erasing a security log, and others. The access process tracking of a directory service is an event log output concerning an Active Directory domain controller. The process tracking is an event log output of, e.g., creation of a process, termination, handle duplication, indirect access acquisition, and others. The change in policy is an event log output, e.g., a change in privilege (which functions as a part of the OS to add a work station to a domain). The logon event is an event log output of, e.g., local logon/logoff. The use of privilege is an event log output of, e.g., a change in a system time, remote forcible shutdown, and others.

Further, each of the primary administrative computer 100A and the secondary administrative computer 100B can execute an administrative console as application software. The administrative console can set a security policy included in administration policy information.

The administrative console administrates data, e.g., user administration information or device administration information. A user name, a password, and a privilege are recorded in the user administration information. A MAC address, an administration division, an administrator name, a device number, a computer name, and others are recorded in the device administration information.

When the primary administrative computer 100A is connected with a network, the primary administrative computer 100A carries out the security server function. When the primary administrative computer 100A is disconnected from the network, the secondary administrative computer 100B executes the security server function and the administrative console.

A description will now be given as to an example where a computer that executes the security server function and the administrative console is changed from the primary administrative computer 100A to the secondary administrative computer 100B.

User administration information and device administration information managed by the administrative console of the primary administrative computer 100A are synchronized with user administration information and device administration information managed by the administrative console of the secondary administrative computer 100B. Further, audit log information and administration policy information managed by a virtual security server of the primary administrative computer 100A are synchronized with audit log information and administration policy information managed by a virtual security server of the secondary administrative computer 1002.

Furthermore, a computer that executes an administrative function is switched from the primary administrative computer 100A to the secondary administrative computer 100B. Likewise, virtual server connection is switched from the primary administrative computer 100A to the secondary administrative computer 100B.

Based on the above-described procedure, the computer that carries out the security server and the administrative console is switched from the primary administrative computer 100A to the secondary administrative computer 100B. Moreover, when switching the computer that carries out the security server and the administrative console from the secondary administrative computer 100B to the primary administrative computer 100A, the same procedure is used to perform switching.

FIG. 2 shows an example where distribution of the administration policy and collection of the audit log are realized by a vertically-distributed configuration where a user interface of the administrative function is separated. An administrative console OS is usually an application that is activated when a setting is changed without utilizing an administrative application, and a virtual server side that works with minimum resources (a CPU utilization ratio, a memory capacity, and others) by a virtual machine monitor in the background usually realizes distribution and collection of information.

As a result, even when the administrative console OS utilized by a user is not activated, invoking the virtual server enables continuing services (distribution and collection of information).

Forming a redundant configuration between a plurality of PCs utilizing the virtual technique as shown in FIG. 2 enables continuing services by a PC that takes over the function by switching the administrative server function or providing and realizing the administrative function for a user even if the PC is taken out or disconnected from the network.

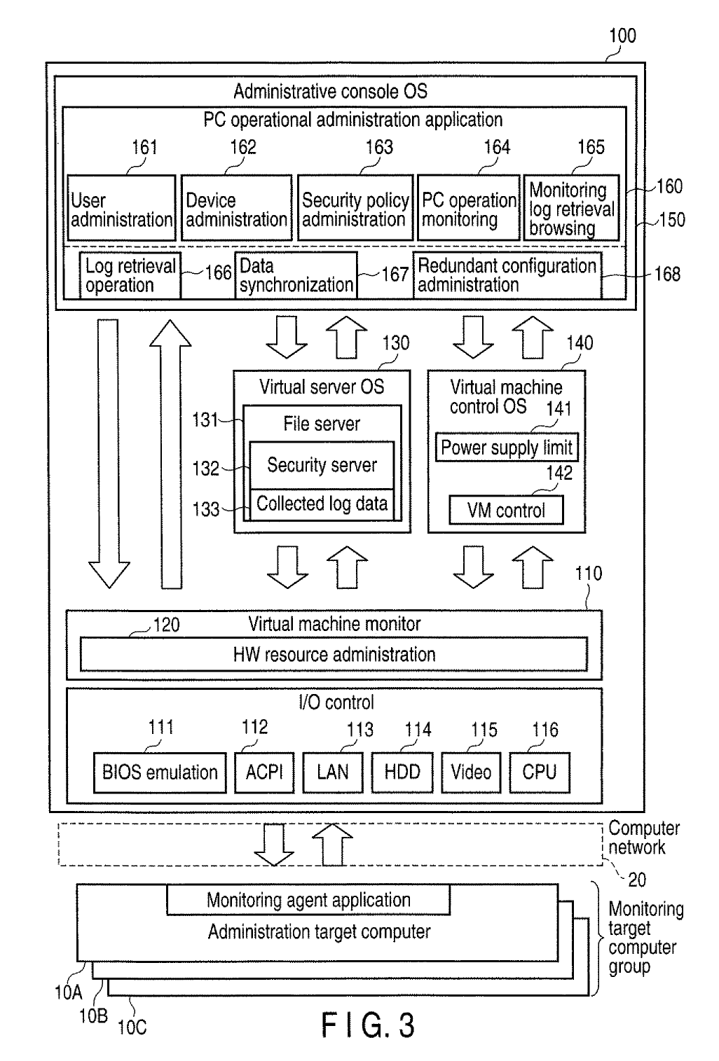

FIG. 3 is a block diagram showing a configuration of an administrative computer and target administration computers.

An administrative computer 100 (100A or 100B) is formed of a virtual machine monitor 110, a virtual server operating system 130, a virtual machine control operating system 140, an administrative console operating system 150, and others.

The virtual server operating system 130, the virtual machine control operating system 140, and the administrative console operating system 150 run on different virtual machines.

A hardware layer has a BIOS emulator 111, an ACPI 112, a LAN controller 113, a hard disk drive (HDD) 114, a graphic processor unit (GPU) 115, a central processing unit (CPU) 116, and others.

The hardware (HW) resource administration module 120 administrates the hardware layer to assign resources to the virtual machines on which the respective operating systems 130, 140, and 150 run. Additionally, the virtual machine monitor 110 has a function of managing an execution schedule for each virtual machine and a function of allocating an I/O request from each virtual machine to the hardware layer.

Software such as a power supply control module 141 or a virtual machine (VM) control module 142 runs on the virtual machine control operating system 140. The power supply control module 141 administrates a power supply in cooperation with the ACPI 112. The virtual machine control module 142 monitors communication of the virtual machines on which the respective operating systems 130 and 160 run with respect to the outside through the LAN controller 113 and communication between the virtual machines on which the respective operating systems 130 and 160 run and executes processing, e.g., filtering.

Software such as a file server 131 runs on the virtual server operating system 130. The file server 131 has data, e.g., a security policy 132 and collected log data 133.

Software such as a PC operation administrative application 160 runs on the administrative console operating system 150. The administrative console operating system 150 is an environment that is usually utilized by a user, and application software such as a Web browser, a mail user agent, a word processor, or spreadsheet software runs besides the PC operation administrative application 160.

In the PC operation administrative application 160, a software module such as a user administrative module 161, a device administrative module 162, a security policy administrative module 163, a PC operation monitoring module 164, a monitoring log retrieval browsing module 165, a log retrieval operation module 166, a data synchronization module 167, or a redundant configuration administrative module 168 runs.

The user administrative module 161 administrates user administration information. The device administrative module 162 administrates device administration information. The security policy administrative module 163 administrates administration policy information. The PC operation monitoring module 164 monitors a computer operation performed by a user based on information stored in an audit log information pool.

The monitoring log retrieval browsing module 165 supplies conditions set by a user to the log retrieval operation module 166. The log retrieval operation module 166 communicates with the file server 131 in the virtual server OS 130 to extract a log meeting the conditions set by the user and acquire it from the file server 131. The monitoring log retrieval browsing module 165 displays a log acquired by the log retrieval operation module 166 in a screen of a display device.

The data synchronization module 167 has a function of synchronizing setting information of the primary administrative computer 100A with that of the secondary administrative computer 100B. The redundant configuration administrative module 168 has a function of managing stop/restart of a redundant configuration between the primary administrative computer 100A and the secondary administrative computer 100B.

A method of automatically recognizing that the target administration computers 10A to 10D have been switched at the time of changeover will now be described.

A machine name that is used in NetBIOS is set to each of the virtual machine on which the virtual server OS 130 of the primary administrative computer 100A runs and the virtual machine on which the virtual server OS 130 of the secondary administrative computer 100B runs.

At the time of changeover, a machine name set to the virtual machine on which the virtual server OS 130 of the secondary administrative computer 100B runs is set to the virtual machine on which the virtual server OS 130 of the primary administrative computer 100A runs, and a machine name set to the virtual machine on which the virtual server OS 130 of the primary administrative computer 100A runs is set to the virtual machine on which the virtual server OS 130 of the secondary administrative computer 100B runs. Then, the virtual machine on which the virtual server OS 130 of the primary administrative computer 100A runs and the virtual machine on which the virtual server OS 130 of the secondary administrative computer 100B runs request update of a relationship between names and IP addresses when transmitting new names, and a WINS server registers the new names and IP addresses. Thereafter, the WINS serer solves the names so that the target administration computers 10A to 10D can recognize the IP addresses of the virtual machines on which the new virtual servers OS 130 run.

An implementation example of a user interface when setting this redundant configuration will now be described hereinafter. In this embodiment, screen contents assuming a configuration including two computers are provided, a configuration including two or more computers or a configuration including a single computer (a redundant configuration cannot be utilized) can be also adopted.

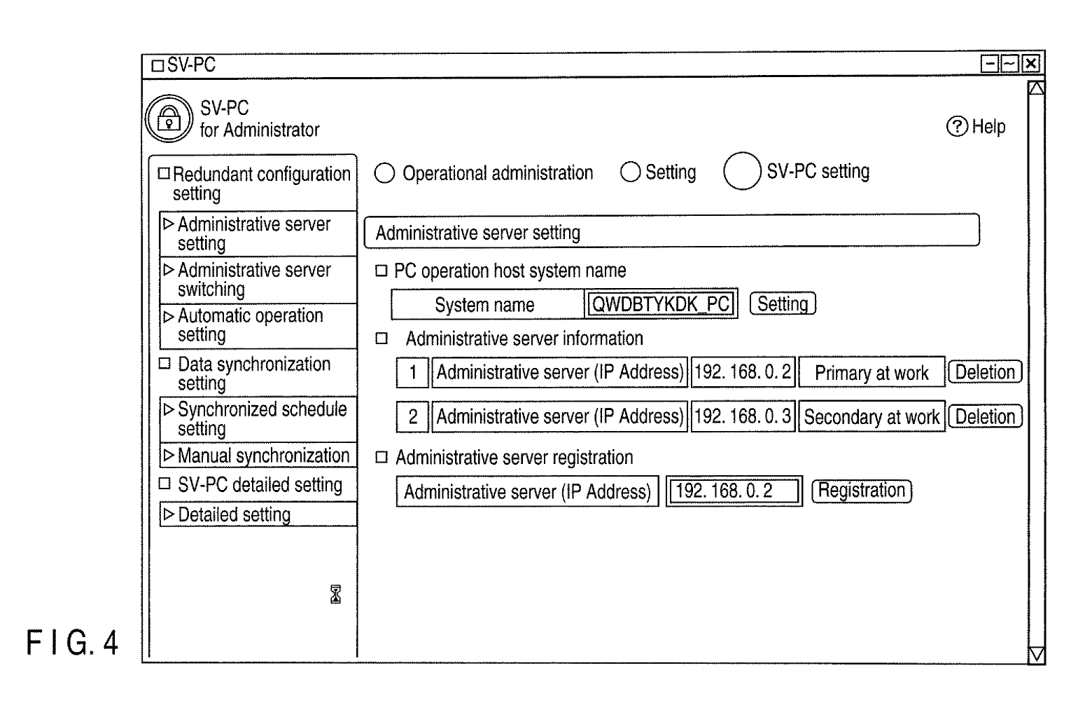

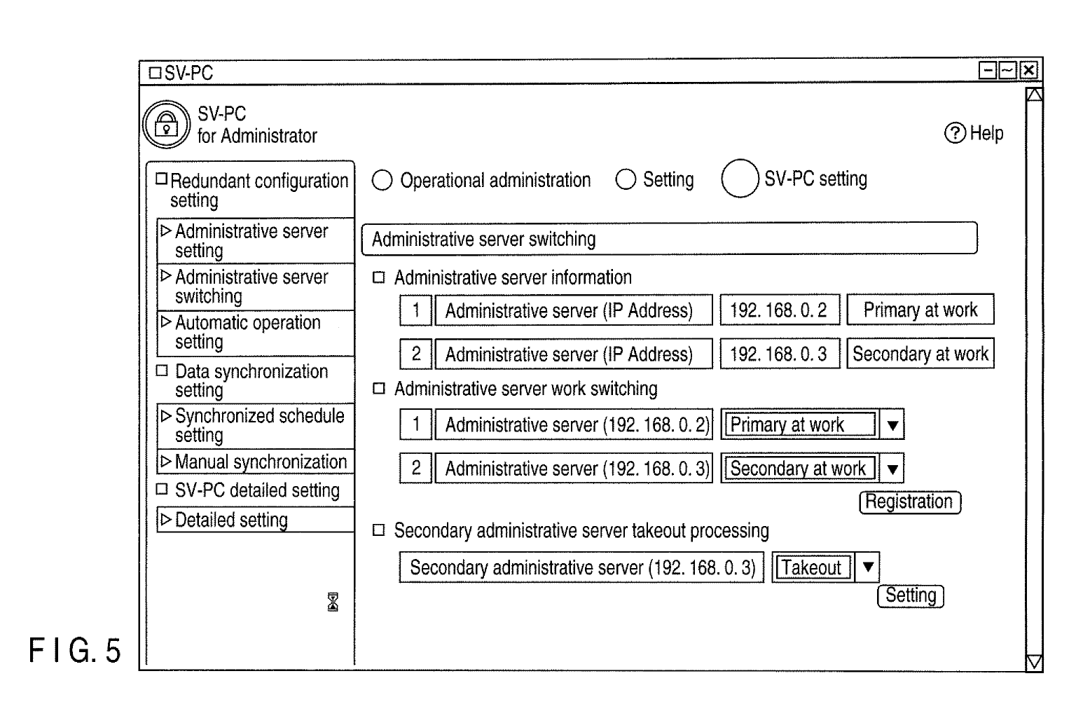

Each of FIGS. 4 and 5 shows an implementation example of a user interface when setting this redundant configuration. In this implementation example, screen contents assuming a configuration including two computers are provided, a configuration including two or more computers or a configuration including a single computer (a redundant configuration cannot be utilized) can be also adopted.

FIG. 4 shows a setting screen that is used to set an administrative server. This system can set a plurality of groups including combinations of two or more administrative computers and target administration computers in an office network. A PC operation host system name is a name required to identify each group.

As administrative server information, an IP address of the administrative server that runs as the primary administrative computer 100A and an IP address of the administrative server that runs as the secondary administrative computer 100B are displayed. A work/non-work status is displayed to be adjacent to each IP address. Further, the setting is deleted by operating a deletion button.

In “Administrative server registration (IP Address)”, an IP address of a computer that is currently running as an administrative server is displayed. When an IP address is input at a position where the IP address is displayed and a registration button is operated, the IP address of the administrative server is registered.

FIG. 5 shows a display screen that is used to switch the administrative servers. IP addresses and work statuses of the two administrative servers are displayed below “Administrative server information”. Two inverse triangle buttons and a registration button which are used to set the two administrative servers displayed in “Administrative server information” to be operated as the primary server or the secondary server are displayed below “Administrative server work switching”. An inverse triangle button and a registration button that are used to set takeout of the secondary administrative server are displayed below “Secondary administrative server takeout processing”. Operating a setup key in a state where “Takeout” is displayed by manipulating the inverse triangle button enables taking out the secondary administrative server.

In the above-described example, the secondary server is stopped to enable disconnection from the system in the redundant configuration including the two primary/secondary servers. Although the user interface example is just an example, stop or disconnection on the primary side can be realized depending on implementation.

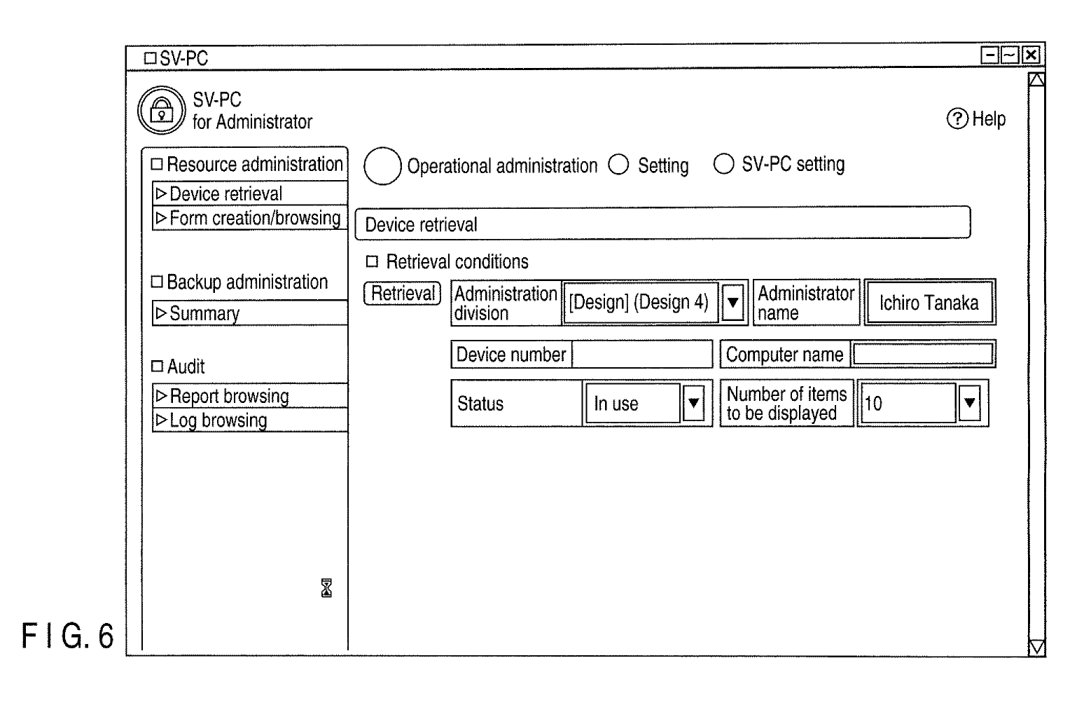

FIG. 6 shows a display screen that is used to retrieve a device. As retrieval conditions, an administration division, an administrator name, a device number, a computer name, a status, and the number of items to be displayed can be input.

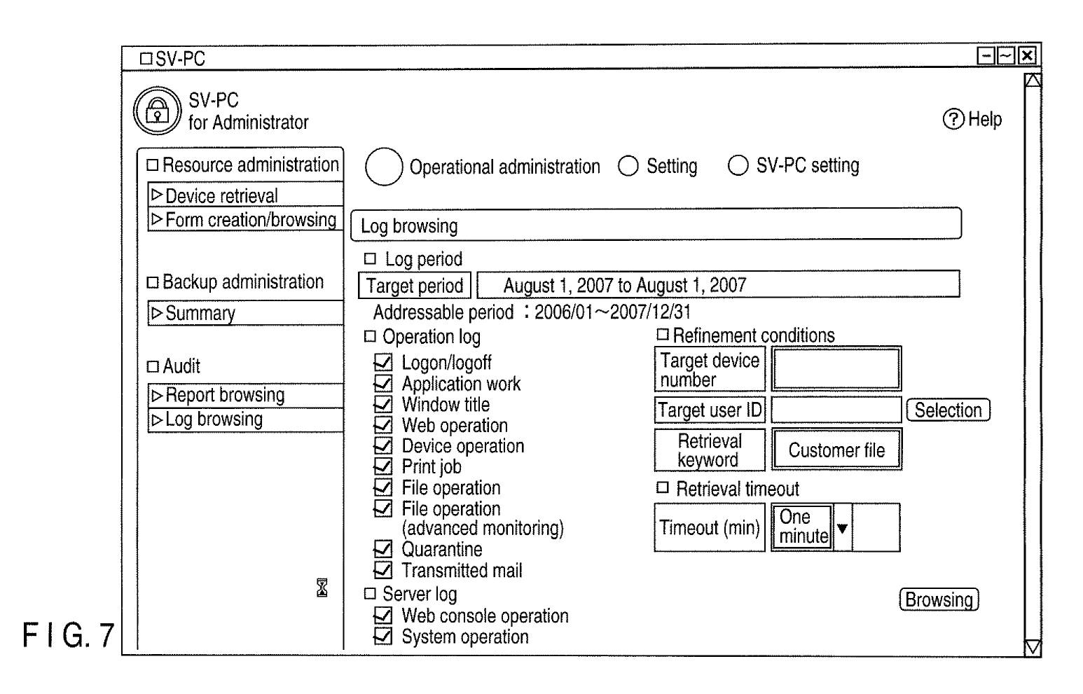

A state where collected pieces of audit log information are synchronized with each other to constantly enable a retrieval function is maintained in virtual server functions. Further, synchronizing respective pieces of setting information with each other in the administrative console also enables maintaining operability even though switching occurs. FIG. 7 shows a setting screen that is used to browse a log.

A period of a log to be browsed can be input on the right-hand side of “Target period” below “Log period. An addressable period is displayed below “Target period”. As types of logs that can be browsed, there are “Logon/logoff”, “Application work”, “Window title”, “Web operation”, “Device operation”, “Print job”, “File operation”, “File operation (advanced monitoring)”, “Quarantine”, and “Transmitted mail”, and each log can be browsed by placing a check mark in a check box. Furthermore, as server logs that can be browsed, there are “Web console operation” and “System operation”, and each log can be browsed by placing a check mark in a check box.

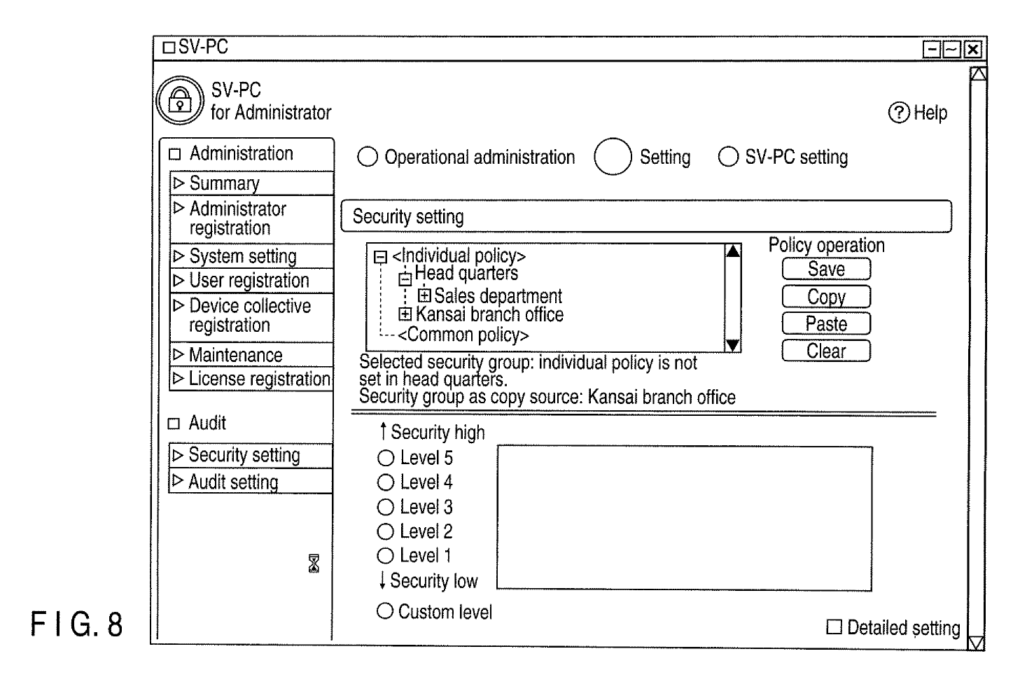

FIG. 8 shows a display screen that is used to set a security policy in each target administration computer. A save button that is used to save a set security policy, a copy button that is used to copy the set security policy, a paste button that is used to paste the set security button, and a clear button that is used to clear the set security button are provided. Moreover, a button required to set a security level to one of levels 1 to 5 and a radio box required to customize the security level are provided. Additionally, a check box that is used to set security in detail is provided.

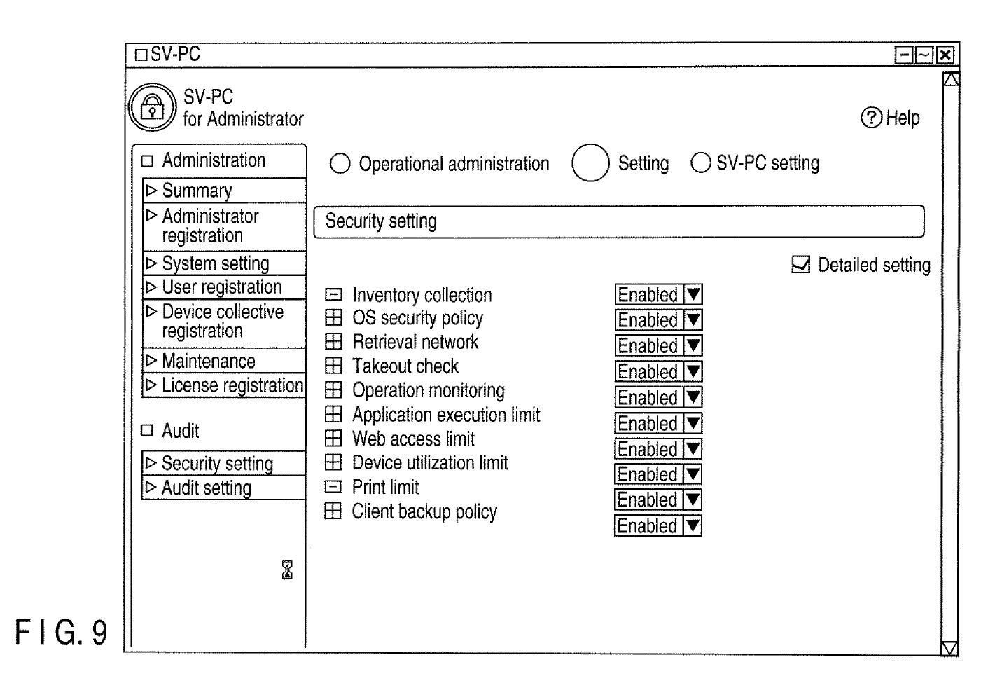

FIG. 9 shows a security setting screen that is displayed when a check mark is placed in the check box provided to set security in detail. In the security setting screen, each of “Inventory collection”, “OS security policy”, “Quarantine network”, “Takeout check”, “Work monitoring”, “Application execution limit”, “Web access limit”, “Device utilization limit”, “Print limit”, and “Client backup policy” can be set to an enabled state or a disabled state.

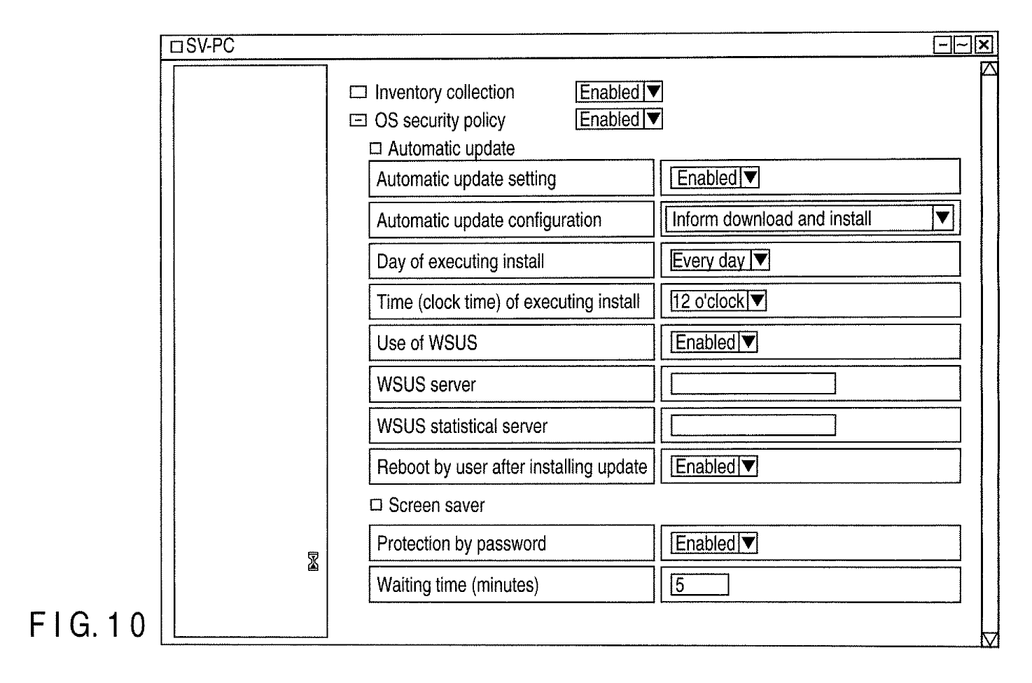

FIG. 10 shows a screen that is used to set “OS security policy” depicted in FIG. 9 in detail. As items of “OS security policy”, there are two items, e.g., automatic update and a screen saver.

The automatic update is an item required to set an automatic update function of Windows Update. The automatic update function of Windows Update is a function of automatically downloading and installing a program that remedies a security hole that is targeted when a hacker attacks a computer. The program that remedies a security hole is acquired from the Microsoft site or a WSUS server that executes a WSUS (Windows Server Update Service) installed in an office. Further, a WSUS statistical server that records an operation log of each target administration computer may be provided in some cases.

In the automatic update, it is possible to set “Setting of automatic update”, “Configuration of automatic update”, “Time (clock time) of executing install”, “Use of WSUS”, “WSUS server”, “WSUS statistical server”, and “Reboot by user after installing update”.

Furthermore, in the screen saver, “Protection by password” and “Waiting time” can be set.

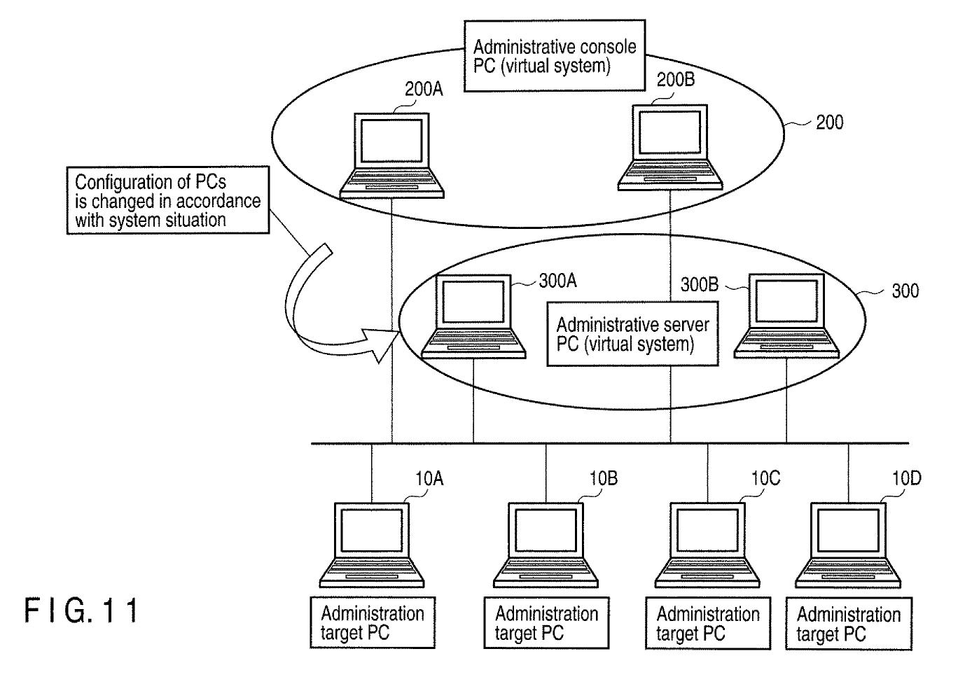

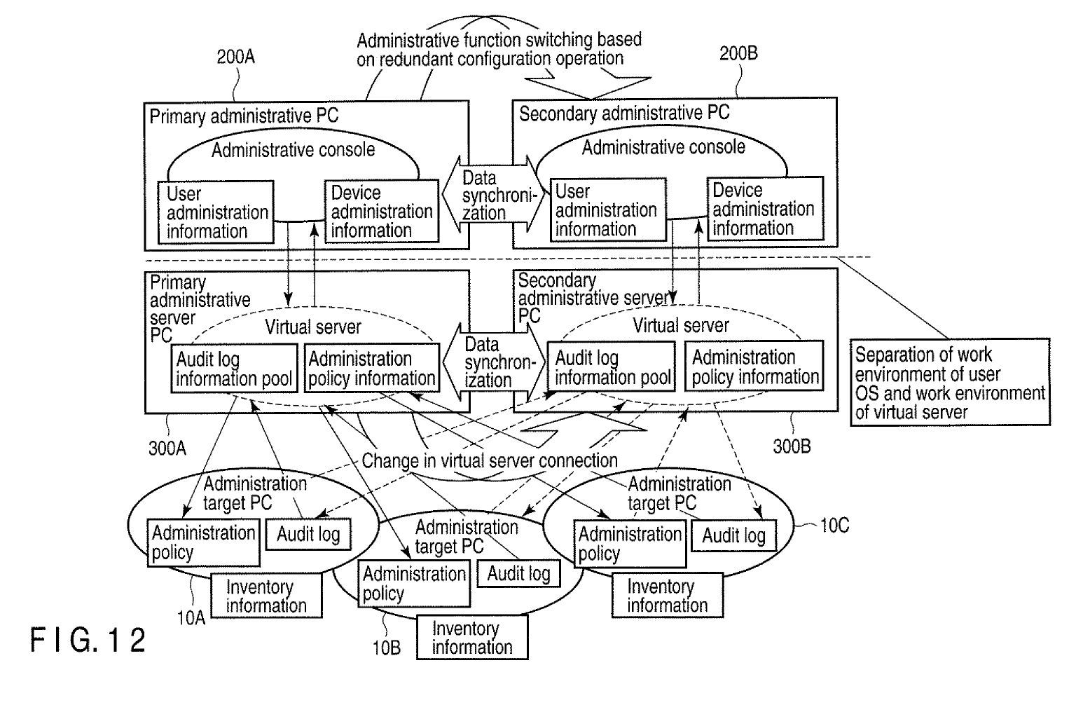

Each of FIGS. 11 and 12 shows an example where computers that execute the administrative function and the virtual server function are carried out in different virtual environments. When the computers that execute the administrative function and the virtual server function in different virtual environments, a degree of freedom in virtual server operation and configuration conditions can be improved.

As shown in FIG. 1, each of a primary administrative console PC 200A and a secondary administrative console PC 200B can carry out an administrative console on a virtual machine. Moreover, each of a primary administrative server PC 300A and a secondary administrative server PC 300B can carry out a security server function on the virtual machine.

As shown in FIG. 12, a computer that carries out the administrative function based on redundant configuration operation can be switched between the primary administrative console PC 200A and the secondary administrative console PC 200B. When switching the computer, user administration information and device administration information provided in the primary administrative console PC 200A are synchronized with user administration information and device administration information provided in the secondary administrative console PC 200B.

Additionally, as shown in FIG. 12, a computer that carries out the virtual machine serving as a virtual server can be switched between the primary administrative server PC 300A and the secondary administrative server PC 300B. When switching the computer, an audit log information pool and an audit log provided in the primary administrative server PC 300A are synchronized with an audit log information pool and an audit log provided in the secondary administrative server PC 300B.

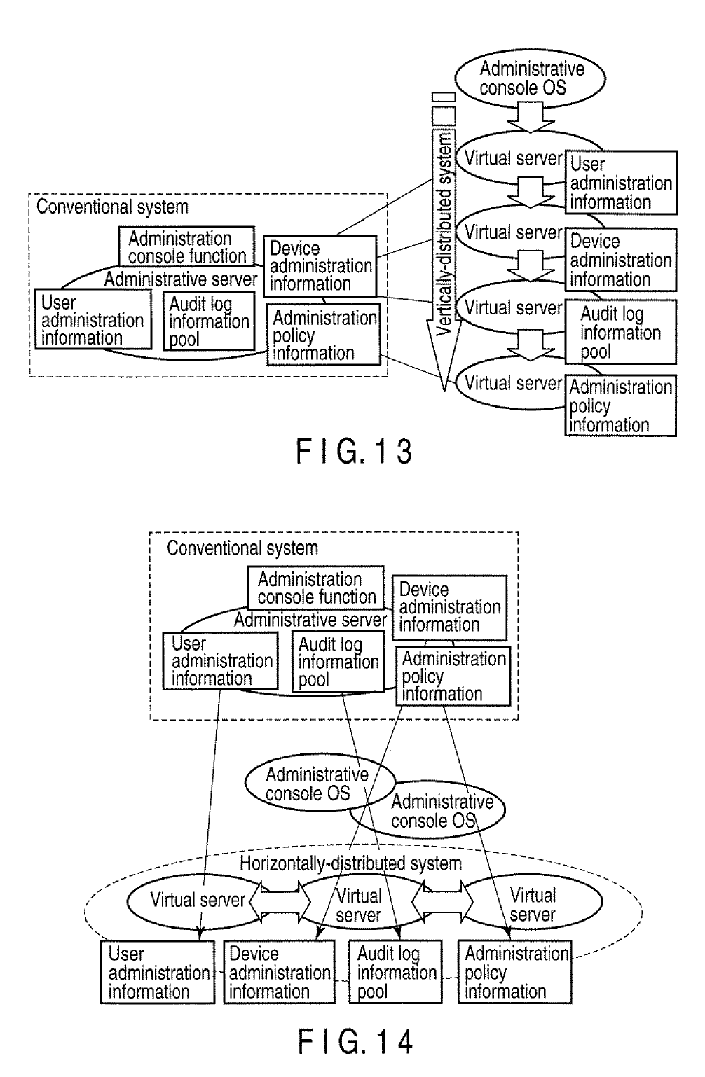

In the example depicted in FIG. 12, since distribution and collection of information are realized by the virtual servers as explained above, such functional decomposition is provided. However, further segmentation can be carried out to distribute the virtual server for information distribution and the virtual server for information collection. This is a vertical distributing function as shown in FIG. 13.

Further, as shown in FIG. 14, in a virtual environment where virtual server functions are separated, availability based on a horizontal distributing function can be improved by realizing distribution of the virtual server functions in a plurality of virtual environments.

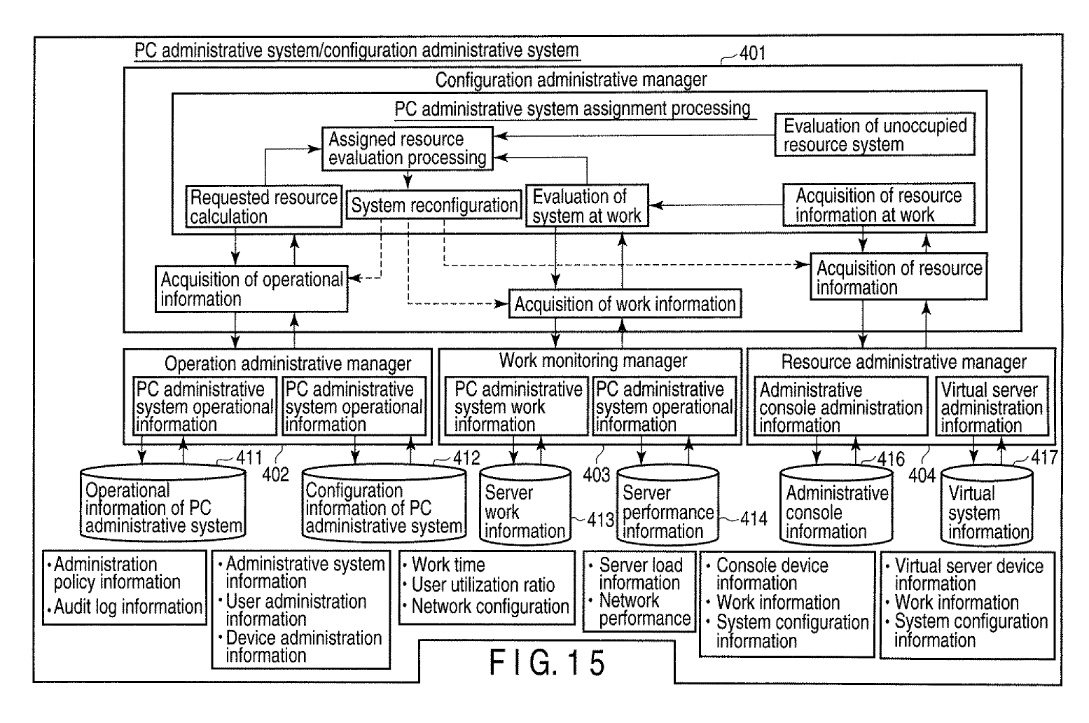

FIG. 15 shows an implementation example for realization of distributed environments. FIG. 15 shows a configuration administrative system that realizes distribution of the virtual environments. The configuration administrative system is formed of respective functions, i.e., a configuration administrative manager 401, an operation administrative manager 402, a work monitoring manager 403, and a resource administrative manager 404. Each manager utilizes a database to maintain information.

The operation administrative manager 402 collects system information in a currently working PC administrative system or a PC administrative system that is to work, and calculates and manages system requirements required by the PC administrative systems. Operational information (an administration policy and an audit log), configuration information (administrative system information, user administration information, device administration information), and other information is held in databases (a PC administrative system operational information database 411 and a PC administrative system configuration information database 412).

The work monitoring manager 403 manages a work status of a currently working PC administrative system or a work status of an unoccupied machine registered in a resource pool, and performs collection of information such as an operating ratio or a utilization ratio or collection of information such as a network configuration or performance of a target machine. Server work information (a work time, a user utilization ratio, and a network configuration), server performance information (server load information and network performance), and other information is held in databases (a server work information database 413 and a server performance information database 414).

The resource administrative manager 404 manages a machine that constitutes a currently working PC administrative system or a machine that is not currently utilized as a resource pool. Device administration information of PC administrative systems is exploited to collect information.

Administrative console information (administrative console device information and a work status (at work/unoccupied)), virtual server information (virtual server device information and a work status (at work/unoccupied)), and others are held in databases (an administrative console information database 416 and a virtual system information database 417).

Information such as configuration/performance/scale of configuration administration is acquired. As machine information required configuring a system, unoccupied resource system/machine information is acquired by the resource administrative manager 404.

Furthermore, the configuration administrative manager 401 determines a system/machine which has a short distance in a network configuration and carries out and utilizes evaluation based on, e.g., a work status from unoccupied resource systems/machines. When an appropriate unoccupied resource system/machine is not present, the configuration administrative manager 401 again acquires information of a currently working system/machine from the resource administrative manager 404 and also determines this system/machine as a candidate. Besides the information acquired from the resource administrative manager 404, the configuration administrative manager 401 also obtains system work information an operating ratio/a utilization ratio), system performance information (a server load and network performance), and other information from the work monitoring manager 403 to evaluate a currently operating system/machine. The configuration administrative manager 401 determines a system/machine to be utilized from all the candidate systems/machines.

In PC administrative system assignment processing of the configuration administrative manager 401, evaluation processing for an assigned resource is executed based on an evaluation result of an unoccupied resource or a currently working system while being compared with information, e.g., configuration/performance/scale of a requested system from the operation administrative manager 402. The configuration administrative manager 401 executed a system reconfiguration instruction process in response to the evaluation processing.

In response to the system reconfiguration instruction process, operational information, work information, and resource information are updated, and information in each database is updated.

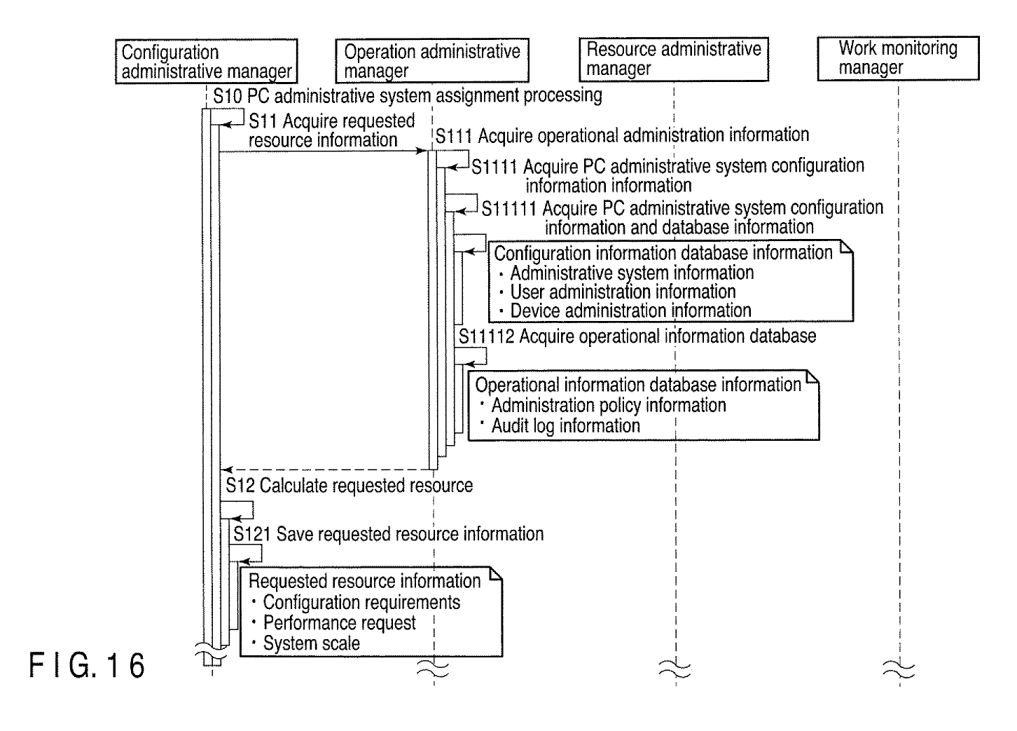

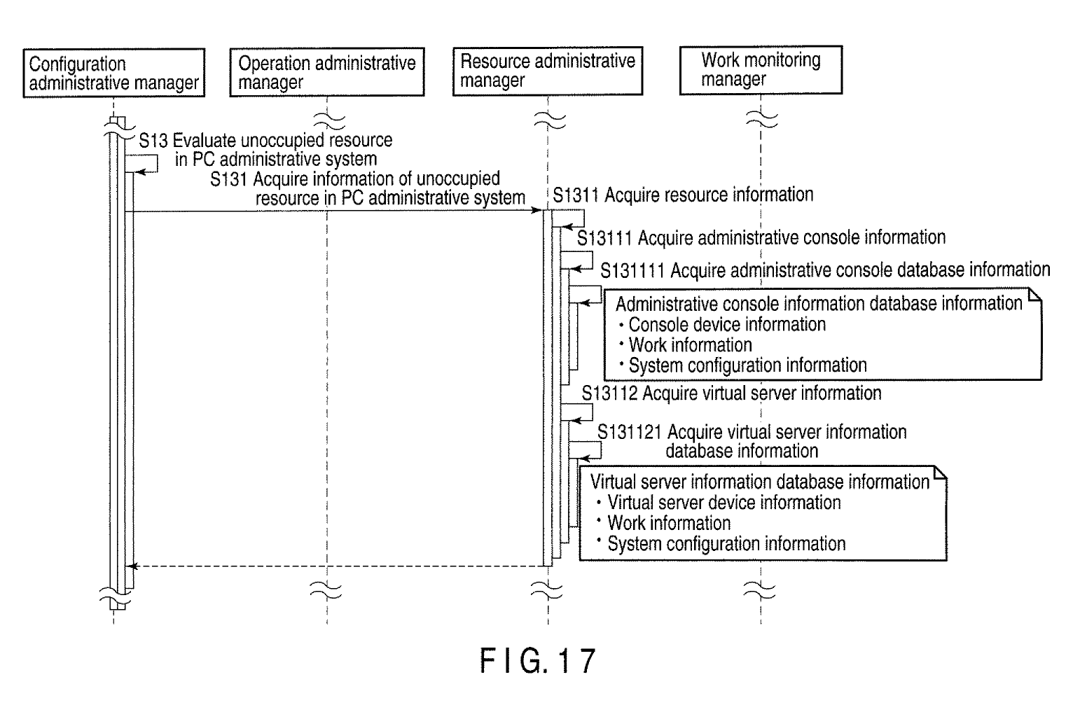

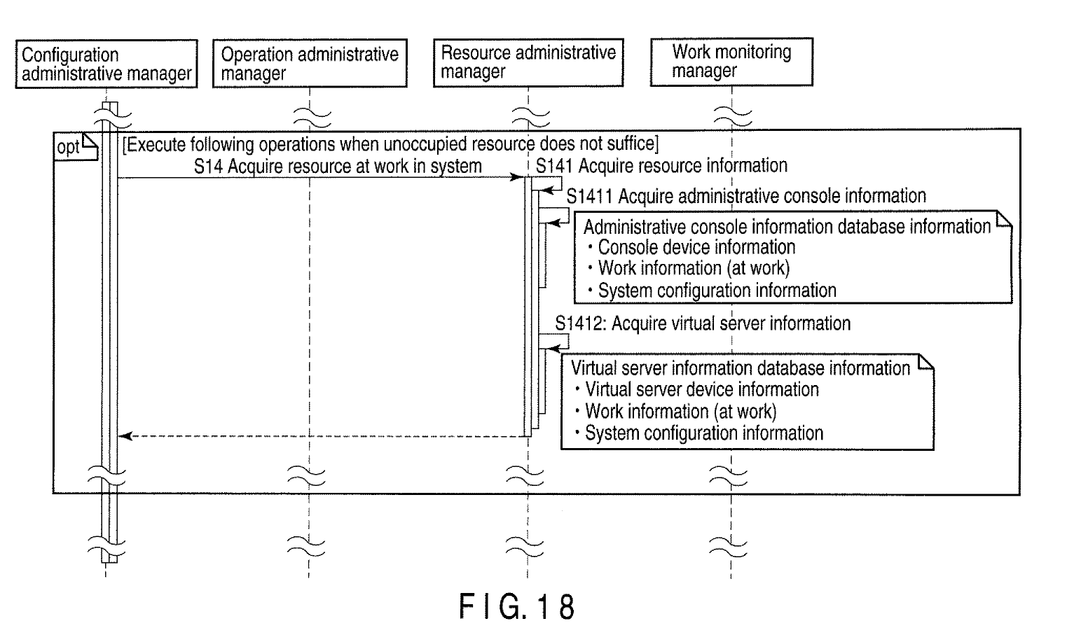

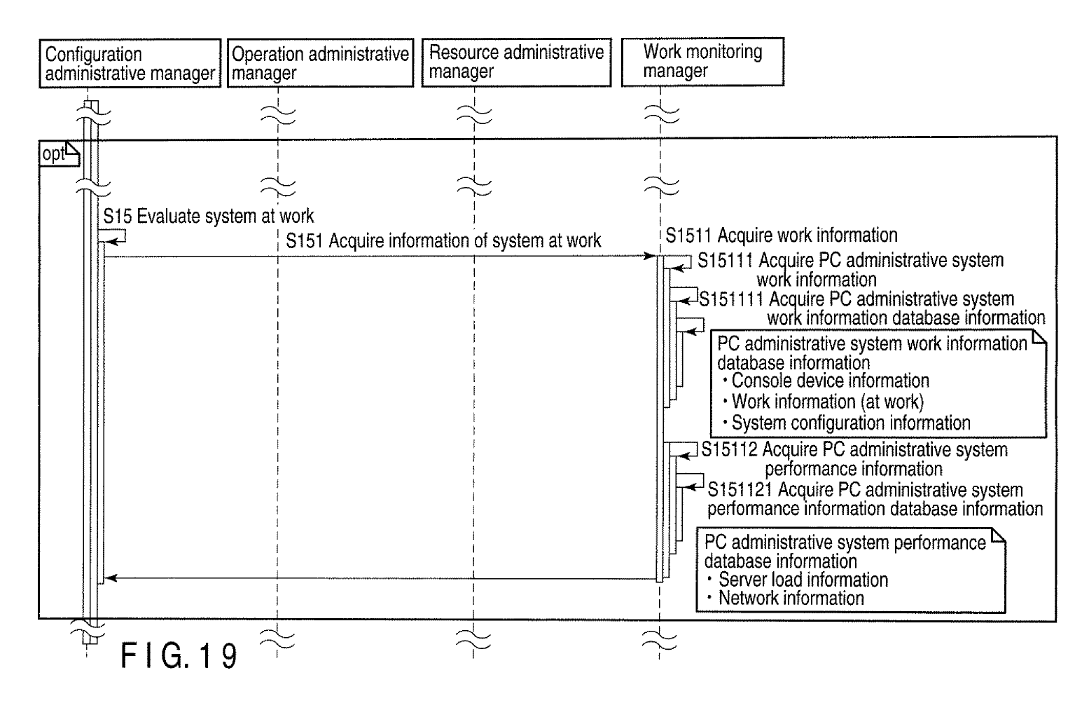

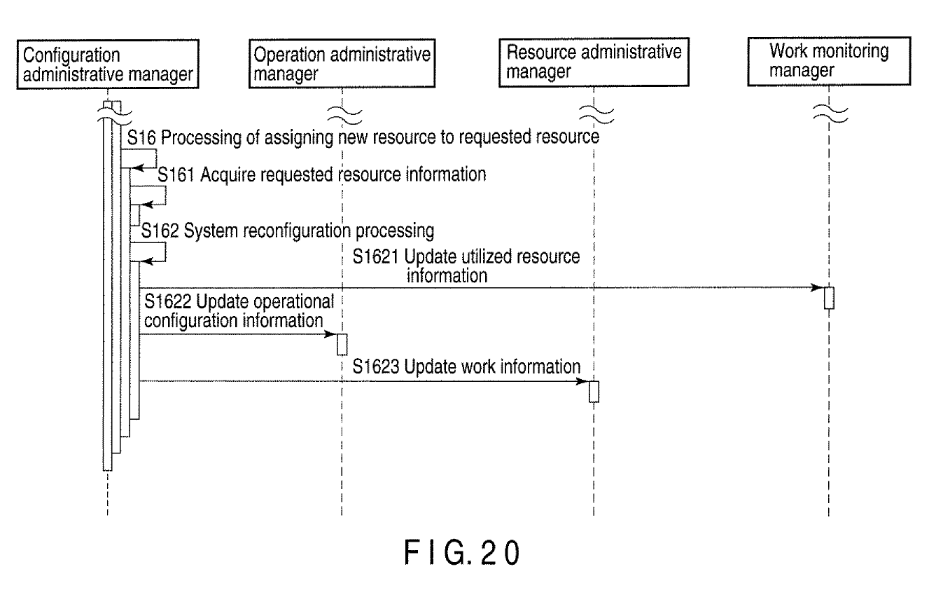

Processing of the configuration administrative manager 401, the operation administrative manager 402, the resource administrative manager 401, and the work monitoring manager 403 will now be described with reference to FIGS. 16 to 20.

First, the configuration administrative manager 401 executes PC administrative system assignment processing (a block S10). To execute the PC administrative system assignment processing, the configuration administrative manager 401 requests the operation administrative manager 402 to transmit information required to calculate a resource (a requested resource) which is necessary when running the administrative server (a block S11).

The operation administrative manager 402 executes processing of acquiring operational administration information (a block S111). The operation administrative manager 402 executes processing of acquiring information configuring the PC administrative system (S1111). The operation administrative manager 402 obtains PC administrative system configuration information database information in order to acquire PC administrative system configuration information (a block S11111). Administrative system information, user administration information, and device administration information are registered in the PC administrative system configuration information database information. The operation administrative manager 402 obtains an operational information database in order to acquire PC administrative system configuration information (a block S11112). Administration policy information and audit log information are registered in the operational information database information. The operation administrative manager 402 transmits the acquired PC administrative system configuration information (the PC administrative system configuration information database information and the operational information database) to the configuration administrative manager 401.

The configuration administrative manager 401 calculates a requested resource based on the PC administrative system configuration information transmitted from the operation administrative manager 402 (a block S12). The configuration administrative manager 401 saves information of the calculated requested resource in a hard disk drive (a block S121). In the requested resource information, configuration requirements, performance requirements, and a system scale are registered.

The configuration administrative manager 401 executes processing of evaluating an unoccupied resource in the PC administrative system (a block S13). To evaluate an unoccupied resource in the PC administrative system, the configuration administrative manager 401 requests the resource administrative manager 404 to transmit unoccupied resource information in the PC administrative system (a block S131).

The resource administrative manager 404 executes processing of acquiring resource information (a block S1311). The resource administrative manager 404 obtains administrative console information in order to acquire the resource information (a block S13111). To obtain the administrative console information, administrative console database information is acquired (a block S131111). In the administrative console database information, console device information, work information, and system configuration information are registered. The resource administrative manager 404 obtains virtual server configuration information in order to acquire the administrative console information (a block S13112). The resource administrative manager 404 obtains virtual server information database information in order to acquire the virtual server configuration information (a block S131121). In the virtual server information database information virtual server device information, work information, and system configuration information are registered. The resource administrative manager 404 transmits the acquired resource information (the administrative console information database information and the virtual server information database) to the configuration administrative manager 401.

A description will now be given as to processing when the requested resource calculated at the block S13 is compared with the transmitted resource information and an unoccupied resource does not suffice for the requested resource.

The configuration administrative manager 401 requests the resource administrative manager 404 transmit information of a resource which is running in the system (a block S14). The resource administrative manager 404 executes processing of acquiring resource information (a block S141). To acquire the resource information, the resource administrative manager 404 obtains administrative console information database information as administrative console information (a block S1411). In the administrative console information database information, console device information, work information (at work), and system configuration information are registered. The resource administrative manager 404 obtains a virtual server information database as virtual server information in order to acquire the resource information (a block S1412). In the virtual server information database information, virtual server device information, work information (at work), and system configuration information are registered. The resource administrative manager 404 transmits the information of a resource which is currently running in the system to the configuration administrative manager 401.

The configuration administrative manager 401 executes processing of evaluating a currently working system (a block S15). The configuration administrative manager 401 instructs the work monitoring manager 403 to acquire working system information (a block S151).

The work monitoring manager 403 executes processing of acquiring work information (a block S1511). The work monitoring manager 403 executes processing of acquiring PC administrative system information in order to obtain the work information (a block S15111). The work monitoring manager 403 acquires PC administrative system working information database information in order to obtain the PC administrative system information (a block S151111). In the PC administrative system work information database information, console device information, work information (running and system configuration information are registered. The work monitoring manager 403 executes processing of acquiring PC administrative system performance information in order to obtain the work information (a block S15112). The work monitoring manager 403 acquires PC administrative system performance information database information in order to obtain the PC administrative system performance information (a block S151121). In the PC administrative system performance information database information, server load information and network information are registered. The work monitoring manager 403 transmits working system information (the PC administrative system work information database information and the PC administrative system performance information database information) to the configuration administrative manager 401. Then, the processing when an unoccupied resource does not suffice for the requested resource is terminated.

The configuration administrative manager 401 executes processing of assigning a new resource to the requested resource (a block S16). The configuration administrative manager 401 acquires the requested resource stored at the block 5121 (a block S161). The configuration administrative manager 401 executes system reconfiguration processing to generate in-use resource information (a block S162). The configuration administrative manager 401 instructs the work monitoring manager 03 to update in-use resource information based on the system reconfiguration processing (a block S1621). The configuration administrative manager 401 instructs the operation administrative manager 402 to update operational configuration information based on the system reconfiguration processing (a block S1622). The configuration administrative manager 401 instructs the resource administrative manager 404 to update work information based on the system reconfiguration processing (a block S1623).

Utilizing the virtual technique enables readily realizing an improvement in availability or workability based on the virtual server operational configuration.

Further, even if the number of PC resources for functions realized by the virtual technique is small, effectively exploiting many utilized PCs by the virtual technique to effect functional decomposition based on vertical distribution or horizontal distribution enables improving performance as compared with a configuration where services are provided by a single PC having a virtual environment.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing system comprising:
a managed information processing apparatus connected with a network;
a plurality of first information processing apparatuses connected with the network, the first information processing apparatus including a first monitor module which controls each software resource to simultaneously run on one hardware resource, the software resources including a first software resource including a first operating system and a first program which runs on the first operating system and has a function of administrating security information required to control an operation of the managed information processing apparatus;
a plurality of second information processing apparatuses connected with the network, the second information processing apparatus including a second monitor module which controls each software resource to simultaneously run on one hardware resource, the software resources including a second software resource including a second operating system and a second program which runs on the second operating system and has a function of collecting and saving log information indicative of an administration status in the managed information processing apparatus;
a plurality of third information processing apparatuses connected with the network, the third information processing apparatus including a third monitor module which controls each software resource to simultaneously run on one hardware resource, the software resources including a third software resource including a third operating system and a third program which runs on the third operating system and has a function of administrating user information which uses the managed information processing apparatus; and
a plurality of fourth information processing apparatuses connected with the network, the fourth information processing apparatus including the fourth monitor module which controls each software resource to simultaneously run on one hardware resource, the software resources including a fourth software resource including the fourth operating system and a fourth Program which runs on the fourth operating system and has a function of administrating device information which uses the managed information processing apparatus,
wherein one first information processing apparatus selected from the plurality of first information processing apparatuses executes the first program, and the security information of the one selected first information processing apparatus is synchronized with that of a newly selected first information processing apparatus when changing the first information processing apparatus which executes the first program from the selected first information processing apparatus to the newly selected first information processing apparatus,
one second information processing apparatus selected from the plurality of second information processing apparatuses executes the second program, and the log information of the one selected second information processing apparatus is synchronized with that of a newly selected second information processing apparatus when changing the second information processing apparatus which executes the second program from the one selected second information processing apparatus to the newly selected second information processing apparatus,
one third information processing apparatus selected from the plurality of third information processing apparatuses executes the third program, and the user information of the one selected third information processing apparatus is synchronized with that of a newly selected third information processing apparatus when changing the third information processing apparatus which executes the third program from the one selected third information processing apparatus to the newly selected third information processing apparatus, and
one fourth information processing apparatus selected from the plurality of fourth information processing apparatuses executes the fourth program, and the device information of the one selected fourth information processing apparatus is synchronized with that of a newly selected fourth information processing apparatus when changing the fourth information processing apparatus which executes the fourth program from the one selected fourth information processing apparatus to the newly selected fourth information processing apparatus.

2. The system of claim 1, wherein, when changing the selected first information processing apparatus to a newly selected first information processing apparatus, a name on NetBIOS of the first software resource of the selected first information processing apparatus is set to a name on NetBIOS of the first software resource of the newly selected first information processing apparatus, and the name on NetBIOS of the first software resource of the newly selected first information processing apparatus is set to the name on NetBIOS of the first software resource of the selected first information processing apparatus,
when changing the selected second information processing apparatus to a newly selected second information processing apparatus, a name on NetBIOS of the second software resource of the selected second information processing apparatus is set to a name on NetBIOS of the second software resource of the newly selected second information processing apparatus, and the name on NetBIOS of the second software resource of the newly selected second information processing apparatus is set to the name on NetBIOS of the second software resource of the selected second information processing apparatus,
when changing the selected third information processing apparatus to a newly selected third information processing apparatus, a name on NetBIOS of the third software resource of the selected third information processing apparatus is set to a name on NetBIOS of the third software resource of the newly selected third information processing apparatus, and the name on NetBIOS of the third software resource of the newly selected third information processing apparatus is set to the name on NetBIOS of the third software resource of the selected third information processing apparatus, and
when changing the selected fourth information processing apparatus to a newly selected fourth information processing apparatus, a name on NetBIOS of the fourth software resource of the selected fourth information processing apparatus is set to a name on NetBIOS of the fourth software resource of the newly selected fourth information processing apparatus, and the name on NetBIOS of the fourth software resource of the newly selected fourth information processing apparatus is set to the name on NetBIOS of the fourth software resource of the selected fourth information processing apparatus.

3. The system of claim 1, wherein the first information processing apparatus, the second information processing apparatus, the third information processing apparatus, and the fourth information processing apparatus are the same information processing apparatus.

4. The system of claim 1, wherein, when changing the selected first information processing apparatus to the newly selected first information processing apparatus, a resource amount required to carry out first software resource is calculated, and the newly selected first information processing apparatus is selected in accordance with an unoccupied resource of the plurality of first information processing apparatuses,
when changing the selected second information processing apparatus to the newly selected second information processing apparatus, a resource amount required to carry out the second software resource is calculated, and the newly selected second information processing apparatus is selected in accordance with an unoccupied resource of the plurality of second information processing apparatuses,
when changing the selected third information processing apparatus to the newly selected third information processing apparatus, a resource amount required to carry out the third software resource is calculated, and the newly selected third information processing apparatus is selected in accordance with an unoccupied resource of the plurality of third information processing apparatuses, and
when changing the selected fourth information processing apparatus to the newly selected fourth information processing apparatus, a resource amount required to carry out the fourth software resource is calculated, and the newly selected fourth information processing apparatus is selected in accordance with an unoccupied resource of the plurality of fourth information processing apparatuses.

5. A control method for an information processing system,
information processing system comprising:
a managed information processing apparatus connected with a network;
a plurality of first information processing apparatuses connected with the network, the first information processing apparatus including a first monitor module which controls each software resource to simultaneously run on one hardware resource, the software resources including a first software resource including a first operating system and a first program which runs on the first operating system and has a function of administrating security information required to control an operation of the managed information processing apparatus;
a plurality of second information processing apparatuses connected with the network, the information processing apparatus including a second monitor module which controls each software resource to simultaneously run on one hardware resource, the of software resources including a second software resource including a second operating system and a second program which runs on the second operating system and has a function of collecting and saving log information indicative of an administration status in the managed information processing apparatus;
a plurality of third information processing apparatuses connected with the network, the third information processing apparatus including a third monitor module which controls each software resource to simultaneously run on one hardware resource, the software resources including a third software resource including a third operating system and a third program which runs on the third operating system and has a function of administrating user information which uses the managed information processing apparatus; and
a plurality of fourth information processing apparatuses connected with the network, the fourth information processing apparatus including the fourth monitor module which controls each software resource to simultaneously run on one hardware resource, the software resources including a fourth software resource including the fourth operating system and a fourth program which runs on the fourth operating system and has a function of administrating device information which uses the managed information processing apparatus,
the system comprising:
executing the first program by one first information processing apparatus selected from the plurality of first information processing apparatuses;
synchronizing the security information of a newly selected first information processing apparatus with the security information of the one selected first information processing apparatus when changing the first information processing apparatus which executes the first program from the selected first information processing apparatus to the newly selected first information processing apparatus;
executing the second program by the one second information processing apparatus selected from the plurality of second information processing apparatuses;
synchronizing the log information of a newly selected second information processing apparatus with the log information of the one selected second information processing apparatus when changing the second information processing apparatus which executes the second program from the one selected second information processing apparatus to the newly selected second information processing apparatus;
executing the third program by one third information processing apparatus selected from the plurality of third information processing apparatuses;
synchronizing the user information of a newly selected third information processing apparatus with the user information of the one selected third information processing apparatus when changing the third information processing apparatus which executes the third program from the one selected third information processing apparatus to the newly selected third information processing apparatus;
executing the fourth program by one fourth information processing apparatus selected from the plurality of fourth information processing apparatuses; and
synchronizing the device information of a newly selected fourth information processing apparatus with the device information of the one selected fourth information processing apparatus when changing the fourth information processing apparatus which executes the fourth program from the one selected fourth information processing apparatus to the newly selected fourth information processing apparatus.

6. The method of claim 5, further comprising:
setting, when changing the selected first information processing apparatus to a newly selected first information processing apparatus, a name on NetBIOS of the first software resource of the selected first information processing apparatus to a name on NetBIOS of the first software resource of the newly selected first information processing apparatus, and setting the name on NetBIOS of the first software resource of the newly selected first information processing apparatus to the name on NetBIOS of the first software resource of the selected first information processing apparatus;
setting, when changing the selected second information processing apparatus to a newly selected second information processing apparatus, a name on NetBIOS of the second software resource of the selected second information processing apparatus to a name on NetBIOS of the second software resource of the newly selected second information processing apparatus, and setting the name on NetBIOS of the second software resource of the newly selected second information processing apparatus to the name on NetBIOS of the second software resource of the selected second information processing apparatus,
setting, when changing the selected third information processing apparatus to a newly selected third information processing apparatus, a name on NetBIOS of the third software resource of the selected third information processing apparatus to a name on NetBIOS of the third software resource of the newly selected third information processing apparatus, and setting the name on NetBIOS of the third software resource of the newly selected third information processing apparatus to the name on NetBIOS of the third software resource of the selected third information processing apparatus; and
setting, when changing the selected fourth information processing apparatus to a newly selected fourth information processing apparatus, a name on NetBIOS of the fourth software resource of the selected fourth information processing apparatus to a name on NetBIOS of the fourth software resource of the newly selected fourth information processing apparatus, and setting the name on NetBIOS of the fourth software resource of the newly selected fourth information processing apparatus to the name on NetBIOS of the fourth software resource of the selected fourth information processing apparatus.

7. The method of claim 5, wherein the first information processing apparatus, the second information processing apparatus, the third information processing apparatus, and the fourth information processing apparatus are the same information processing apparatus.

8. The method of claim 5, further comprising:
calculating, when changing the selected first information processing apparatus to the newly selected first information processing apparatus, a resource amount required to carry out the first software resource, and selecting the newly selected first information processing apparatus in accordance with an unoccupied resource of the plurality of first information processing apparatuses;
calculating, when changing the selected second information processing apparatus to the newly selected second information processing apparatus, a resource amount required to carry out the second software resource, and selected the newly selected second information Processing apparatus in accordance with an unoccupied resource of the plurality of second information processing apparatuses;
calculating, when changing the selected third information processing apparatus to the newly selected third information processing apparatus, a resource amount required to carry out the third software resource, and selecting the newly selected third information processing apparatus in accordance with an unoccupied resource of the plurality of third information processing apparatuses; and
calculating, when changing the selected fourth information processing apparatus to the newly selected fourth information processing apparatus, a resource amount required to carry out the fourth software resource, and selecting the newly selected fourth information processing apparatus in accordance with an unoccupied resource of the plurality of fourth information processing apparatuses.
